(19) United States
(12) Patent Application Publication
(10) Pub. No.: US 2010/0251474 A1
(43) Pub. Date: Oct. 7, 2010

(54) SWIMMING POOL SAFETY COPING ELEMENT AND METHOD OF MANUFACTURING THE SAME

(76) Inventor: Mark Nicholas Hempleman-Adams, Gloucestershire (GB)

Correspondence Address: MORRISON & FOERSTER LLP, 1650 TYSONS BOULEVARD, SUITE 400, MCLEAN, VA, 22102, US

(21) Appl. No.: 12/738,766

(22) PCT Filed: Sep. 29, 2008
(86) PCT No.: PCT/GB08/03269

§ 371 Date: Jun. 16, 2010

(30) Foreign Application Priority Data
Oct. 18, 2007 (GB) 0720397.9
Oct. 18, 2007 (GB) 0720398.7
Dec. 13, 2007 (GB) 0724310.8
Dec. 19, 2007 (GB) 0724709.1

(51) Int. Cl. E04H 4/06; B28B 7/24; E04H 4/14

(52) U.S. Cl. 4/504; 264/254

(57) ABSTRACT

In a method of manufacturing a swimming pool safety coping element (5,40) comprising a first portion (110) and a second portion (120) disposed upon the first portion, the method comprises the steps of forming the second portion (120) from a second material, wherein a surface of the second portion (120) comprises an interlocking component, positioning the second portion in a mould to enable a first material to be received by the interlocking component, introducing the first material into the mould and curing the coping element. A swimming pool safety coping element (5, 40) is also disclosed, comprising a first portion (110) formed from a first resilient material, a second portion (120), disposed thereon, formed from a second resilient material, wherein an in between the first portion and the second portion comprises interlocking means (125) whereby an interlocking component, formed on the second portion (120) is configured to receive the first material, the thereby secure the first portion (110) to the second portion (120). A swimming pool safety coping element (5, 40) is also disclosed, comprising a Low Surface Energy material.

The present invention relates to coping, in particular coping elements used around the edge of a swimming pool.

Conventional coping elements installed around the edge of swimming pools are made from materials such as stone, concrete and reconstituted stone. Such coping stones are often formed with a bull nose or rounded exposed edge so that corners are eliminated from their profile in order to minimise the danger associated therewith. However, a hazardous surface is still present when these conventional coping stones are installed. If a user of the swimming pool was to slip or misjudge their entry into the water, they could collide with the coping stone and receive an injury, potentially a serious injury.

It is an aim of the present invention to provide an alternative coping product having an improved safety characteristic.

According to a first aspect, the present invention provides a swimming pool safety coping element comprising:
a first portion formed from a first resilient material; and
a second portion, disposed on the firstportion, formed from a second resilient material, wherein an interface between the first portion and the second portion comprises interlocking means whereby an interlocking component formed on the second portion is configured to receive the first material, during manufacture of the coping element, to thereby secure the first portion to the second portion.

By providing a coping element comprising resilient materials, if a user were to impact the coping element with significant force, some of the energy of the impact would be absorbed by the coping element as the coping element would be able to deform under the impact. Any resulting injury would, consequently, be significantly less than a corresponding impact with a conventional non-resilient coping stone made from, for example, concrete. By providing an interface between the two resilient materials with an interlocking means a mechanical bond between the two portions can be achieved. Thus, even materials which are otherwise incompatible for chemical bonding may be used in combination and a coping elementhaving enhanced properties is provided.

The interlocking member may comprise a chamber or recess which may be formed within the second portion or may depend therefrom. Alternatively, or in addition, the interlocking component may comprise a complex, protruding member. By complex we refer to the geometry of the member e.g. having lateral sub-members or describing a convoluted shape such as a spiral or comprising one or more loops.

The second material may be softer than the first material. The first material may comprise one of the group of polyurethane, epoxy, latex, block copolymer, polyethylene foam, polypropylene foam and glass reinforced plastic (GRP). The second material may comprise a silicone compound and/or ethylene vinyl acetate and/or a block copolymer.

The second material may comprise luminescent material, capable of visually defining the edge of a swimming pool in low lighting conditions. For example a phosphor such as strontium aluminate and or zinc sulphide may be used.

According to a second aspect the second invention provides a method of manufacturing a swimming pool coping element comprising a first portion and a second portion disposed upon the first portion, the method comprising the steps of:
forming the second portion from a second material, wherein a surface of the second portion comprises an interlocking component;
positioning the second portion in a mould to enable a first material to be received by the interlocking component;
introducing the first material into the mould; and
curing the coping element.

In providing a method whereby the second portion is initially formed having an interlocking component, the material of the first portion can then be brought into contact with the second portion. The first material, upon introduction into the mould, is received by the interlocking component so that when the first material goes off and hardens it is permanently secured about or within the interlocking component and the materials become mechanically interlocked. Thus the materials are secured to one another and a unitary coping element is provided, even in circumstances where the first material is chemically incompatible with the second material such that they cannot be chemically bonded to one another.

The interlocking component may comprise a chamber or recess and the first material may be received by the chamber via a port thereof during the introducing step. The interlocking component may comprise a complex, protruding member, whereby the protruding member is engulfed by the first material during the aforementioned introducing step.

The forming step may comprise an extruding step or it may comprise an injection moulding step. The curing step may be undertaken at an elevated temperature in the range of 50-60° C., this has the advantage of speeding up the hardening process. The first material may comprise one of the group of a silicone compound, ethylene vinyl acetate and a block copolymer. The second material may comprise a resin and a hardener.

According to a third aspect, the present invention provides a swimming pool safety coping element comprising:
a first portion comprise one of the group of polyurethane, epoxy, latex, block copolymer, polyethylene foam, polypropylene foam and glass reinforced plastic (GRP);
a second portion, disposed on the first potion, comprising a Low Surface Energy material.

The Low Surface Energy (LSE) material may be one of the group of a silicone compound, ethylene vinyl acetate and a block copolymer.

The second portion may comprise a luminescent material for example strontium illuminate or zinc sulphide.

According to a fourth aspect, the present invention provides a swimming pool safety coping element comprising a Low Surface Energy material for example, one of the group of a silicone compound, ethylene vinyl acetate and a block copolymer. The coping element may comprise a luminescent material, for example a phosphor such as strontium illuminate or zinc sulphide.

By Low Surface Energy material we mean a material having a surface energy below 25 dynes/cm, preferably below 23 dynes/cm.

Preferred features of the present invention will now be described, by way of example only, with reference to the accompanying drawings in which:

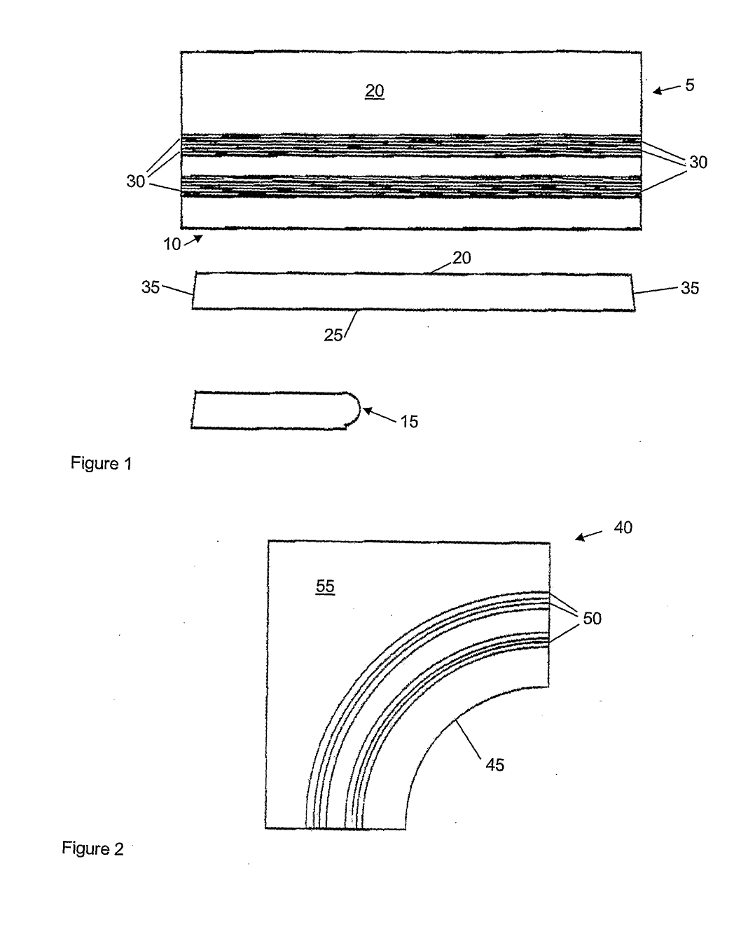

FIG. 1 illustrates a straight coping element;

FIG. 2 illustrates a corner coping element;

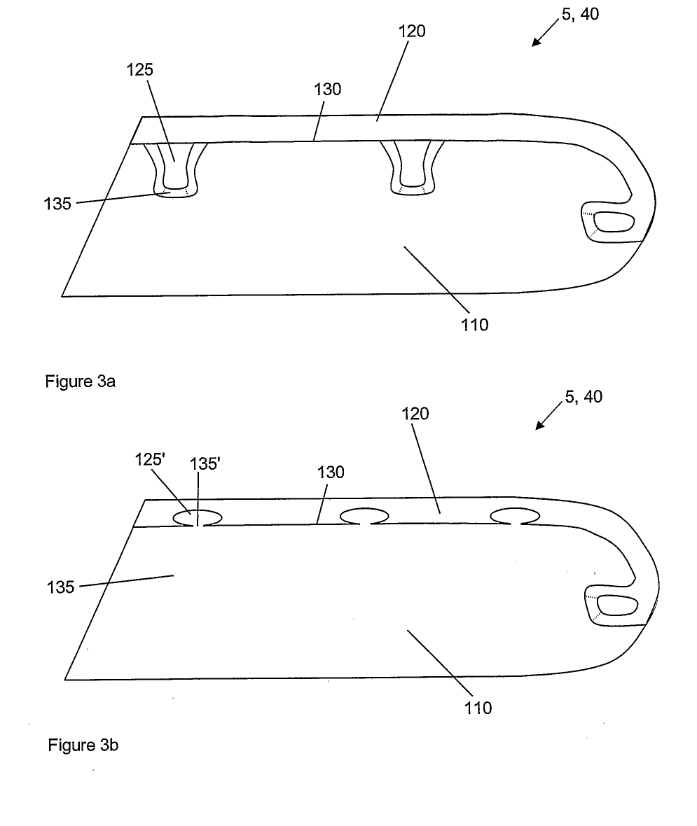

FIG. 3a illustrates a cross section of a coping element;

FIG. 3b illustrates a cross section of another coping element; and

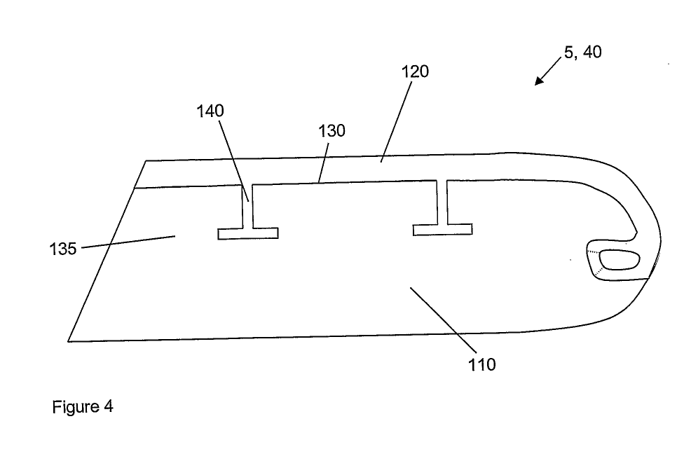

FIG. 4 illustrates a cross section of a further coping element.

FIG. 1 illustrates a straight coping element 5 to be installed along the edge of a swimming pool. The coping element 5 of tie present embodiment is depicted as an approximately cuboid slab having dimensions in the region of 230 mm×610 mm×75 mm. As illustrated, a front edge 10 of the coping element 5 has a bull nose profile, in other words a convex surface is provided so that a smooth continuous profile extends from an upper surface 20 of the slab to a bottom surface 25 of the slab. This smooth profile is presented towards the swimming pool upon installation of the coping element 5.

The upper surface 20 of the coping element 5 is preferably provided with texture to enhance anti-slip properties of the coping element 5. In this embodiment, the texture is provided by two sets of four substantially parallel grooves 30.

As shown, lateral edges 35 of the coping element 5 stone that are configured to be positioned proximate another coping element are provided with a slight taper so that the coping elements can be placed in direct contact with one another at a lower portion and the resulting gaps between the elements at an upper portion can subsequently be filled and sealed with a sealant material, e.g. a silicone or polyurethane sealant material.

The coping element 40 illustrated in FIG. 2 is configured to join together two orthogonally placed, straight coping elements 5. In other words, it represents a corner coping element. The convex (in plan) edge 45 which is presented towards the swimming pool is provided with a bull nose profile to match that of the straight coping element 5. Furthermore, texture, in this embodiment grooves 50, are provided on an upper surface 55 of the corner coping element 40 to match those of an adjacent straight coping element 5.

The dimensions suggested in this embodimentare appropriate for many configurations of rectangular swimming pools. However, it should be noted that alternatively dimensioned and shaped coping elements may be provided. For example, rather smaller elements may be appropriate around a Jacuzzi, and a kidney shaped pool will require alternatively shaped coping elements having different curvature. Further, the bull nose profile described above may be replaced with a flat edge if, for example, the coping element is to approximate a flag stone.

A cross section of each of the coping elements 5, 40 is illustrated in FIG. 3. The coping element 5 comprises a first portion 110 made from a first material that provides the bulk of the coping element 5, 40. A second portion 120 is disposed upon the first portion 110 and is made from a softer resilient material.

The first portion 110 is made from a resilient material, for example a resin compound. In this embodiment, the resin used to form the first portion 110 is polyurethane. Other example resin compounds which may be used are epoxy, latex, block copolymer, polyethylene foam, polypropylene foam and glass reinforced plastic (GRP).

Each of these resin compounds are formed by mixing two products together. The first product, ‘component A’ is the bulk resin e.g. polyurethane. The second product, ‘component B’ is a hardening material, for example aliphatic isocyanate. Upon mixing component A with component B a chemical reaction takes place to form the final material of the first portion 110.

The quantities of component A and component B that are introduced to one another are chosen to ensure that stoichiometry of the resulting mixture is achieved in a known manner.

The second portion 120 is, preferably, made from a softer material than that used for the first portion 110. A silicone compound may be used as such a material has particularly desirable properties in that is particularly grippy (slip resistant) and soft, both of which are desirable when enhancing the safety aspect of a coping element. Unfortunately, silicone compounds do not lend themselves to being chemically bonded to other materials such as those listed above for the first portion.

In order to secure a silicone based second portion 120 to a first portion 110, the second portion 120 is formed first using an extrusion or injection moulding technique. Interlocking members are formed on or in an inner surface 130 of the second portion 120. In one embodiment, illustrated in FIG. 3, the interlocking members are provided by reservoirs or recesses 125 being formed on the inner surface 130 of second portion 120. Ports 135 are formed in a wall of the, or each, reservoir 125 so that material may pass there into during manufacture. The reservoirs 125′ may be formed within the second portion 120, as illustrated in FIG. 3b.

The preformed second portion 120 is located in a mould (not shown) and arranged such that the, or each, port 135 is exposed and is, therefore, able to receive material that is subsequently introduced into the mould.

In an alternative embodiment, illustrated in FIG. 4, the interlocking members are provided by complex, protruding members 140, here T sectioned members, formed on the inner surface 130. During manufacture, material engulfs these members 140 to thereby interlock the first portion 110 to the second portion 120.

Components A and B are mixed and then poured into the mould as a homogeneous mixture. The homogeneous mixture is readily received within each reservoir 125 and the remainder of the coping element, namely the first portion 110 is formed The coping element 5 may then be left to cure at an ambient temperature or the filled mould may be placed into an oven at around 50° C. in order to speed up the curing process. This latter part of the method of manufacture is referred to as a two part cold pour system, alternative methods of manufacture include a blown foam rapid injection system, an injection moulded system, an EPDM moulded system, a latex/rubber moulded system and rubber crumb/or EPDM with resin binder system.

Alternative, materials for the second portion 120 include the class of Low Surface

Energy materials e.g. ethylene vinyl acetate (EVA) or a block copolymer such as Evoprene®.

In practice, the second portion 120 represents a smaller volume than the first portion 110 in order to achieve a cost effective solution. It may be desirable to provide a second portion 120 having a greater volume with respect to the first portion 110. This serves to further improve the compliance of the coping element, 5. Indeed, the entire coping element 5 can be formed from a homogeneous material e.g. a silicone compound.

Swimming pools are typically designed to have aesthetic appeal, the coping elements of the present invention can be enhanced by incorporating decorative objects within the material of the second portion during extrusion prior to curing. Examples of decorative elements include shells, pebbles, coloured beads, preformed shapes made from a plastics material, metal or wood. However these examples are not intended to be restrictive and many suitable materials may be used alone or in combination.

Furthermore, an additional safety feature can be included within the coping elements 5, 40 of the present invention. Materials having luminescent properties can be embedded into the second portion. The luminescent materials may be phosphors such as strontium aluminate or zinc sulphide. The luminescent materials help to define the edge of the swimming pool as the ambient light reduces at the end of the day or during bad weather.

Paving elements can be manufactured having the same constitution as the luminescent coping elements. These paving elements can be laid in a path leading to the swimming pool to assist in defining a path to the pool.

In summary, coping elements are provided that are made from a material having a degree of resilience such that when a user of the swimming pool trips and falls or otherwise misplaces their footing upon entry into the pool and comes into contact with the edge of the pool the injury sustained by the user during the impact is significantly less severe than would be the case if conventional coping stones were installed at the edge of the swimming pool.

1. A method of manufacturing a swimming pool safety coping element comprising a first portion and a second portion disposed upon the first portion, the method comprising the steps of:
forming the second portion from a second material, wherein a surface of the second portion comprises an interlocking component;
positioning the second portion in a mould to enable a first material to be received by the interlocking component;
introducing the first material into the mould; and
curing the coping element.

2. A method according to claim 1, wherein the interlocking component comprises a chamber and the first material is received by the chamber via a port thereof, during the introducing step.

3. A method according to claim 1 or claim 2, wherein the interlocking component comprises a complex protruding member, the protruding member being engulfed by the first material during the introducing step.

4. A method according to any preceding claim, wherein the forming step comprises an extruding step.

5. A method according to any preceding claim, wherein the forming step comprises an injection moulding step.

6. A method according to any preceding claim, wherein the first material comprises one of the group of a silicone compound, ethylene vinyl acetate and a block copolymer.

7. A method according to any preceding claim, wherein the second material comprises a resin and a hardener.

8. A swimming pool safety coping element comprising:
a first portion formed from a first resilient material; and
a second portion, disposed on the first potion, formed from a second resilient material, wherein an interface between the first portion and the second portion comprises interlocking means whereby an interlocking component formed on the second portion is configured to receive the first material, during the manufacture of the coping element, to thereby secure the first portion to the second portion.

9. A coping element according to claim 8, wherein the interlocking component comprises a chamber.

10. A coping element according to claim 8 or claim 9, wherein the interlocking component comprises a complex protruding member.

11. A coping element according to any of claims 8 to 10, wherein the second material is softer than the first material.

12. A coping element according to any of claims 8 to 11, wherein the first material comprises one of the group of polyurethane, epoxy, latex, block copolymer, polyethylene foam, polypropylene foam and glass reinforced plastic (GRP).

13. A coping element according to any of claims 8 to 12, wherein the second material comprises one of the group of a silicone compound, ethylene vinyl acetate and a block copolymer.

14. A coping element according to any of claims 8 to 13, wherein the second material comprises a luminescent material such as a phosphor.

15. A coping element according to claim 14, wherein the luminescent material is strontium aluminate or zinc sulphide.

16. A swimming pool safety coping element comprising:
a first portion comprising one of the group of polyurethane, epoxy, latex, block copolymer, polyethylene foam, polypropylene foam and glass reinforced plastic (GRP); and
a second portion, disposed on the first potion, comprising a Low Surface Energy material.

17. A coping element according to claim 16, wherein the Low Surface Energy material is one of the group of a silicone compound, ethylene vinyl acetate and a block copolymer.

18. A coping element according to claim 16 or claim 17, wherein the second portion comprises a luminescent material.

19. A swimming pool safety coping element comprising a Low Surface Energy material

20. A coping element according to claim 19, wherein the Low Surface Energy material is one of the group of a silicone compound, ethylene vinyl acetate and a block copolymer.

21. A coping element according to claim 19 or claim 20, comprising a luminescent material.

22. A coping element according to claim 1817 or claim 21, wherein the luminescent material comprises a phosphor.

23. A coping element according to claim 22, wherein the luminescent material is strontium aluminate or zinc sulphide.
